(19) United States
(12) Patent Application Publication
(10) Pub. No.: US 2017/0028356 A1
(43) Pub. Date: Feb. 2, 2017

(54) SYSTEM AND METHOD FOR POINT OF USE/POINT OF ENTRY WATER TREATMENT

(71) Applicant: ECONOPURE WATER SYSTEMS, LLC, Tustin, CA (US)

(72) Inventors: Michael Sean MOTHERWAY, Santa Ana, CA (US); Diem Xuan VUONG, San Clemente, CA (US); Curtis ROTH, Rancho Palos Verdes, CA (US)

(73) Assignee: Econo Pure Water Sysrems ,LLC

(21) Appl. No.: 15/100,235

(22) PCT Filed: Dec. 5, 2014
(86) PCT No.: PCT/US2014/068942

§ 371 Date: May 27, 2016

Related U.S. Application Data
(60) Provisional application No. 61/913,170, filed on Dec. 6, 2013.

(51) Int. Cl. B01D 65/08; C02F 1/28; C02F 1/44; B01D 61/02; B01D 63/10

(52) U.S. Cl. CPC B01D 65/08; B01D 61/025; B01D 61/027; B01D 63/10; C02F 1/441; C02F 1/442; C02F 1/281; C02F 1/283; B01D 2321/2091; B01D 2311/2626

(57) ABSTRACT

Water treatment systems and methods are provided to beneficially use the concentrate stream for other, non-potable, use. Embodiments of the invention use the distribution pressure to drive the membrane process and are configured in line with household plumbing so the concentrate is directed through the treatment system but bypassing the treatment mechanism to other uses in the building. In embodiments of this system, only the purified water that is needed for potable consumption is extracted from the water with the rest proceeding to its intended destination at the same pressure.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Patent Application No. 61/913,170 filed Dec. 6, 2013. The aforementioned application is incorporated by reference herein in its entirety, and is hereby expressly made a part of this specification.

### BACKGROUND OF THE INVENTION

Field of the Invention

This application relates to the field of water and waste water treatment. More particularly, this application relates to a membrane system for treating water and waste water and use the concentrate stream for other, non-potable, uses.

Description of the Related Art

While there are many methods to remove impurities from water, membrane treatment is becoming far more common as technologies improve and water sources become more contaminated. Membrane treatment entails providing a pressure differential across a semi-permeable membrane. The differential allows relatively smaller water molecules to flow across the membrane while relatively larger contaminants remain on the high pressure side. As long as the contaminants are larger than the pores in the membrane, the contaminants can be effectively filtered out by the membrane and removed with the concentrate. Some membranes combine size exclusion with electrostatic repulsion as in the case of reverse osmosis and nanofiltration membranes.

Different membranes can be used for different raw water sources and treatment goals. Classifications of membranes generally fall into four broad categories, generally defined by the size of contaminants screened out by the membrane. This size can loosely be correlated to the pore size in the membrane. The four broad categories of membranes are, in decreasing order of the size of materials screened, microfiltration (MF) membranes (which are capable of screening materials with atomic weights between about 80,000 and about 10,000,000 Daltons); ultrafiltration (UF) membranes (which are capable of screening materials with atomic weights between about 5,000 and about 400,000 Daltons); nanofiltration (NF) membranes (which are capable of screening materials with atomic weights between about 180 and about 15,000 Daltons); and reverse osmosis (RO) membranes (which are capable of screening materials with atomic weights between about 30 and about 700 Daltons).

MF and UF membrane systems are typically operated under positive pressures of, for example, 3 to 40 psi, or under negative (vacuum) pressures of, for example, −3 to −12 psi, and can be used to remove particulates and microbes. MF and UF membranes may be referred to as “low-pressure membranes.” NF and RO membranes, in contrast, are typically operated at higher pressures than MF and UF membrane systems, and can be used to remove dissolved solids, including both inorganic and organic compounds, from aqueous solutions. NF and RO membranes may be referred to as “osmotic membranes.” Osmotic membranes are generally charged, adding to their ability to reject contaminants based not only on pore size but also on the repulsion of oppositely-charged contaminants such as many common dissolved solids. Reverse osmosis (RO), nanofiltration (NF) and, to some extent, ultrafiltration (UF) membranes can be used in cross-flow filtration systems which operate in continuous processes (as opposed to batch processes) at less than 100% recovery.

Reverse Osmosis is a membrane process that acts as a molecular filter to remove 95 to 99% of dissolved salts and inorganic molecules, as well as organic molecules. Osmosis is the natural process which occurs when water or another solvent spontaneously flows from a less-concentrated solution, through a semi-permeable membrane, and into a more concentrated solution. In Reverse Osmosis the natural osmotic forces are overcome by applying an external pressure to the concentrated solution (feed). Thus the flow of water is reversed and desalinated water (permeate) is removed from the feed solution, leaving a more concentrated salt solution (brine). Product water quality can be further improved by adding a second pass of membranes, whereby product water from the first pass is fed to the second pass. In a reverse osmosis process as is typically commercially employed, pretreated seawater is pressurized to between 850 and 1,200 pounds per square inch (psi) (5,861 to 8,274 kPa) in a vessel housing, e.g., a spiral-wound reverse osmosis membrane. Seawater contacts a first surface of the membrane, and through application of pressure, potable water penetrates the membrane and is collected at the opposite side. The concentrated brine generated in the process, having a salt concentration up to about twice that of seawater, is disposed back into the ocean.

RO and NF membranes can be composed of a thin film of polyamide deposited on sheets of polysulfone or other substrate. One common form of RO or NF membrane is a thin film composite flat sheet membrane that is wound tightly into a spiral configuration. UF membranes are more commonly provided as hollow fiber membranes, but can also be used in spiral wound elements. The spiral elements make efficient use of the volume in a pressure vessel by tightly fitting a large area of membrane into a small volume. A spiral element typically consists of leaves of back to back flat sheet membranes adjoining a perforated tube. Between the back to back membranes of each leaf is a permeate carrier sheet that conveys the treated water around the spiral (through the leaf) to the central perforated collection tube. A feed water spacer is wound into the spiral to separate adjacent leaves (and/or keep the same leaf from touching itself upon winding). After the leaves are wound against each other they are as close together as about 0.5 to 0.8 millimeters (about the thickness of the physical feed (raw water) spacer that is rolled up with the membrane leaves). The feed water spacer maintains an adequate channel between the membrane leaves so that pressurized feed water can flow between them.

The spiral wound membrane element has become ubiquitous in the field of advanced water treatment and even in non-water separation applications. The spiral membrane element and many supporting components have been designed for the most common applications but there are other applications that call for alternative designs of the components that go with the spiral membrane element. Specifically, the pressure vessel traditionally used for a spiral wound membrane element is designed for several elements in-line.

Spiral membrane elements are traditionally oriented horizontally and the feed water travels through the membranes one time and the concentrate is what is left at the end of the vessel. However, the once-through paradigm is not necessary for a spiral membrane system, so an alternative vessel design is possible for re-circulating feedwater systems. A much larger diameter vessel can array the spiral elements in parallel rather than in series. Access to the interior of the pressure vessel is a concern for these large vessels as an opening the size of the entire diameter would be extremely unwieldy and expensive. These large vessels typically have a large openings and heavy caps. When access is required for a large opening it requires an expensive connection and the heavy cap requires lifting devices such as forklifts or cranes.

Fouling is the single greatest maintenance issue associated with membrane water treatment. Fouling occurs when contaminants in the water adhere to the membrane surfaces and/or lodge into the membrane pores. Fouling creates a pressure loss in the treatment process, increasing energy costs and reducing system capacity. Numerous cleaning methods have been developed to de-foul membranes but they are complex, require significant downtime and often do not fully restore the flux of the membranes.

### SUMMARY OF THE INVENTION

The embodiments are directed to water treatment systems and methods for point of use/point of entry water treatment that beneficially use the concentrate stream for other, non-potable, uses.

In a first aspect, a water treatment system is provided. The system includes a vessel configured to hold a volume of a liquid containing membrane foulants, the vessel having an inlet and a permeate outlet, the vessel installed in line with a water feed line; and a membrane element disposed within the pressure vessel, the membrane element having one or more membrane sheets spaced apart at a spacing from about 1 mm to about 8 mm; and an antifouling apparatus configured to deliver a supply of antifouling particles to the liquid, wherein the antifouling particles are configured to coat membrane surfaces of the membrane element to form a protective layer that attracts and holds membrane foulants while allowing passage of permeate through the membrane element; wherein the spacing of the membrane sheets of the membrane element is configured to reduce a longitudinal head loss of the water feed such that a concentrate stream maintains a preselected distribution pressure. In some embodiments, the membrane element is a spiral-wound membrane element. In some embodiments, the membrane element is a reverse-osmosis or nanofiltration membrane element. In some embodiments, the antifouling particles have a specific surface area of 10 m²/g or more. In some embodiments, the antifouling particles have a specific surface area of 30 m²/g or more. In some embodiments, the antifouling particles have a specific surface area of 500 m²/g or more. In some embodiments, the antifouling particles have a major dimension of 0.5 microns or more. In some embodiments, the antifouling particles have a major dimension of 1.0 micron or more. In some embodiments, the antifouling particles are configured to adsorb membrane foulants having a diameter of 1 micron or less. In some embodiments, the antifouling particles comprise diatomaceous earth. In some embodiments, the antifouling particles comprise activated carbon. In some embodiments, the one or more membrane sheets of the membrane element are spaced apart at a spacing of at least 3 mm. In some embodiments, the system further includes a supply of pellets configured to inhibit the buildup of membrane foulants on the membrane element. In some embodiments, a volume of the pellets is between about 0.5% and about 10% of the volume of the liquid. In some embodiments, the pellets have a density greater than about 1.0 g/mL. In some embodiments, the pellets have nonspherical shape. In some embodiments, the pellets have a major dimension which is less than or equal to about half the spacing between the one or more membrane sheets of the spiral-wound reverse osmosis or nanofiltration membrane element.

In a second aspect, a method of treating a liquid containing membrane foulants is provided. The method includes the steps of supplying a liquid containing membrane foulants to a vessel, the vessel having an inlet, a permeate outlet, and a membrane element disposed within the vessel, the vessel installed in line with a water feed line, the membrane element having one or more membrane sheets spaced apart at a spacing of from about 1 mm to about 8 mm; coating membrane surfaces of the membrane element to form a protective layer that attracts and holds membrane foulants while allowing passage of permeate through the membrane element; applying a pressure differential across the membrane element so as to drive a filtration process across the membrane element, wherein the spacing of the membrane sheets reduces a longitudinal head loss of the water feed line such that the feed line or a concentrate stream maintains a distribution pressure; and collecting the permeate from the permeate outlet in a collection vessel such that as the volume of permeate in the collection vessel increases the pressure differential across the membrane element decreases to slow the filtration process across the membrane element. In some embodiments, the membrane element is a spiral-wound membrane element. In some embodiments, the membrane element is a reverse-osmosis or nanofiltration membrane element.

Another embodiment is a method substantially as described herein.

Another embodiment is a system substantially as described herein.

### BRIEF DESCRIPTION OF THE DRAWINGS

FIGS. 1A-F show a pressure vessel including a membrane element for a water treatment system according to an embodiment.

FIG. 2A shows a side view of a pressure vessel including a membrane element according to an embodiment.

FIG. 2B shows the cross section of the pressure vessel of FIG. 2A.

FIG. 3A illustrates a cross-section of a traditional spiral wound membrane element.

FIG. 3B illustrates a cross-section of a spiral wound membrane element with improved spacing that may be used for point of use/point of entry water treatment, according to an embodiment.

FIG. 4A is a schematic cross-sectional view of a feed channel between two membrane elements, with pellets added to the feed water, in accordance with another embodiment.

FIG. 4B is a schematic cross-sectional view of a feed channel between two membrane elements, with antifouling particles and pellets added to the feed water and with a layer of antifouling particles coating the membranes, according to another embodiment.

FIG. 5 is a process flow diagram illustrating a method of point of use/point of entry water treatment, according to an embodiment.

FIG. 6 is a process flow diagram illustrating a method of point of use/point of entry water treatment, according to another embodiment.

FIG. 7 is a process flow diagram illustrating a method of point of use/point of entry water treatment, according to another embodiment.

FIG. 8 is a process flow diagram illustrating a method of point of use/point of entry water treatment, according to another embodiment.

FIG. 9 is a process flow diagram illustrating a method of point of use/point of entry water treatment, according to another embodiment.

### DETAILED DESCRIPTION OF THE PREFERRED EMBODIMENTS

The features, aspects and advantages of the present invention will now be described with reference to the drawings of several embodiments, which are intended to be within the scope of the invention herein disclosed. These and other embodiments will become readily apparent to those skilled in the art from the following detailed description of the embodiments having reference to the attached figures, the invention not being limited to any particular embodiment(s) disclosed.

Conventional reverse osmosis desalination plants expose reverse osmosis membranes to high-pressure saltwater. This pressure forces water through the membrane while preventing (or impeding) passage of ions, selected molecules, and particulates therethrough. Desalination processes are typically operated at a high pressure, and thus have a high energy demand. Various desalination systems are described in U.S. Pat. No. 3,060,119 (Carpenter); U.S. Pat. No. 3,456,802 (Cole); U.S. Pat. No. 4,770,775 (Lopez); U.S. Pat. No. 5,229,005 (Fok); U.S. Pat. No. 5,366,635 (Watkins); and U.S. Pat. No. 6,656,352 (Bosley); and U.S. Patent Application No. 2004/0108272 (Bosley); the disclosures of each of which are hereby incorporated by reference in their entireties.

For drinking water systems, water that enters a building from a distribution system or local well is often not of sufficient quality for human consumption and requires further treatment in order to be consumed safely. Many systems today perform this treatment with a significant waste of water. These treatment systems often use cross-flow membranes whereby only a small fraction, as low as 5%, of the water is treated and the rest is wasted. This waste stream is often called the concentrate or brine stream.

The systems address the waste stream problem by providing a mechanism and process to beneficially use the concentrate stream for other, non-potable, uses within the building. Today traditional membrane systems use the pressure of the distribution system to drive the treatment process whereby the two resultant streams are collected at little or no pressure. The systems use the distribution pressure to drive the membrane process but are configured in line with the household plumbing so the concentrate is directed through the treatment system (though bypassing the treatment mechanism) to other uses in the building. In embodiments of this system, only the purified water that is needed for potable consumption is extracted from the water with the rest proceeding to its intended destination at the same pressure. In some embodiments, systems may be installed in line with a household sink used to purify or treat water used for drinking, etc. while the rest of the water may be used for washing dishes, hands, etc. In other embodiments, systems may be installed where a water feed source enters a commercial building, such as an apartment building.

Systems are provided for purifying and/or desalinating water and using the concentrate for other, non-potable, uses. The systems involve exposure of one or more membranes, such as nanofiltration (NF) or reverse osmosis (RO) membranes, to hydrostatic pressure. The membrane is subjected to a pressure that is sufficient to overcome the sum of the osmotic pressure of the feed water (or raw water) that exists on the first side of the membrane and the transmembrane pressure loss of the membrane itself.

In preferred embodiments, one or more membrane units are in a pressure vessel configured to hold water to be treated. Source water may be obtained from a water holding tank. The membrane unit has a feed water side and a permeate side. The feed water side is exposed to the water pressure of the source water and the permeate side is exposed to and fluidicly connected to a permeate holding tank, such as bladder tank. The pressure differential between the source water and the pressure in the bladder tank drives a filtration process across the membrane. In some embodiments, the membrane units or elements are configured in an “open” configuration, with adjacent membrane elements being spaced apart by a greater distance than in conventional osmotic membrane systems, and without a conventional continuous feed water spacer disposed between adjacent active membrane surfaces on the feed water side. Such a configuration can both inhibit settlement of bacteria and/or particles on the membrane and can also reduce longitudinal head loss as compared to conventional systems. In some embodiments, the membrane elements are arrayed vertically within the pressure vessel.

The systems involve exposure of one or more membranes, such as nanofiltration (NF) or reverse osmosis (RO) membranes, to a volume of water held at pressure in a pressure vessel. The vessel pressure can be tailored to the selected membranes and the treatment goals. In embodiments employing an osmotic membrane (one that removes a portion of dissolved solids), for example, the minimum operating pressure required would be the sum of the osmotic pressure differential of the feed water and permeate, the transmembrane pressure, and the longitudinal head loss through the vessel.

The system uses a loosely packed spiral wound membrane element with large open feed spacers or no feed spacer such that the pressure loss is negligible longitudinally through the element and particles or other contaminants that would foul or clog the elements will pass through the system. The system includes a unique membrane element configuration disposed inside a pressure vessel, with real time anti-fouling systems integrated into the vessel. In some embodiments, pressurized feed water is pumped into the vessels and feed water is separated into permeate and concentrate by a cross-flow membrane process. The membranes can include nanofiltration or reverse osmosis spiral-wound membranes. This configuration avoids the “dead spots” that are formed in the feed water flow path by conventional feed water spacers. Spacing between the membranes (to avoid the sheets' tendency to attract one other via surface tension and to lessen head loss) can be maintained by any suitable means. In some embodiments, additional spacers can be disposed between one or more edges of adjacent membrane sheets to keep the membranes from collapsing toward each other. In some embodiments, spacers can be disposed along the leading edges of the membrane elements, with the circulation of the water helping to maintain the spacing of the membrane elements along the flow path. In some embodiments, adjacent membrane sheets are spaced further apart than traditional spiral wound elements, for example, by at least about 2 mm. In other embodiments, the adjacent membrane sheets are spaced apart by at least about 4 mm, at least about 6 mm, at least about 8 mm, or at least about 10 mm. The greater spacing, combined with the absence of a conventional webbed feed water spacer sheet, keeps adjacent membrane sheets from attracting to each other and touching as a result of surface tension. The greater spacing and absence of a conventional continuous feed water spacer also significantly reduce the longitudinal head loss through the system as compared to a conventional spiral membrane system.

The systems of preferred embodiments utilize membrane modules of various configurations. Water (permeate) passes through the membranes and into an enclosed volume, where it is collected. Particularly preferred embodiments employ rigid separators to maintain spacing between the membranes on the low pressure (permeate) side; however, any suitable permeate spacer configuration (e.g., spacers having some degree of flexibility or deformability) can be employed which is capable of maintaining a separation of the two membrane sheets. The spacers can have any suitable shape, form, or structure capable of maintaining a separation between membrane sheets, e.g., square, rectangular, or polygonal cross section (solid or at least partially hollow), circular cross section, I-beams, and the like. Spacers can be employed to maintain a separation between membrane sheets in the space in which permeate is collected (permeate spacers), and spacers can maintain a separation between membrane sheets in the area exposed to raw or untreated water (e.g., raw water spacers). Alternatively, configurations can be employed that do not utilize raw water spacers. Instead, separation can be provided by the structure that holds the membranes in place, e.g., the supporting frame. Separation can also be provided by, e.g., a series of spaced expanded plastic media (e.g., spheres), corrugated woven plastic fibers, porous monoliths, nonwoven fibrous sheets, or the like. In addition, separation can be achieved by weaving the membrane unit or units through a series of supports. Similarly, the spacer can be fabricated from any suitable material. Suitable materials can include rigid polymers, ceramics, stainless steel, composites, polymer coated metal, and the like. As discussed above, spacers or other structures providing spacing are employed within the space between the two membrane surfaces where permeate is collected (e.g., permeate spacers), or between active membrane surfaces exposed to raw water (e.g., raw water spacers).

In one embodiment, the membrane element for this system is constructed with a far more open feed channel as compared to traditional RO membrane elements. This system sacrifices packing density, unit of membrane area per unit of vessel volume, for water savings. The feed spacer used in a spiral wound element is typically the primary factor in determining an element's packing density. The wider open feed channels preferably allow water to pass through the element without losing much pressure while also avoiding the particulate fouling that is common in traditional membrane elements. The pressure is preferable for using the water for non-potable loads in the building. A traditional tight spiral wound membrane element will generally require much greater pressure to push the feed water through the element and non-potable loads will be limited in flow rate and pressure.

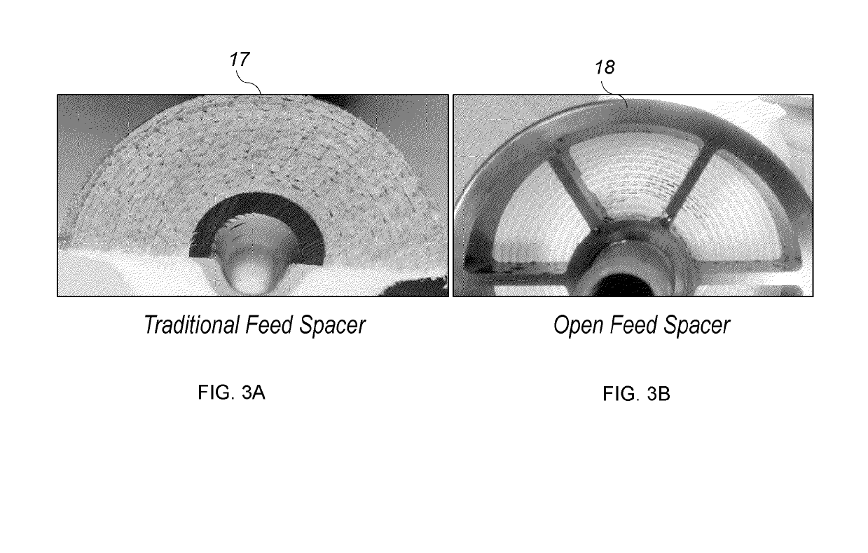

FIGS. 3A and 3B illustrate a comparison of the cross section of two spiral wound membrane elements. The traditional element 17 is designed for maximal packing density and the feed channels are not visible in the cross section photo. However, the membrane element 18 used in one system has much larger channels with no cross members blocking them.

The membrane element preferably used in the system is different than traditional point-of-use treatment membranes as it desirably dramatically reduces the cross membrane (longitudinal) pressure drop in order to preserve pressure for distribution throughout the building of the concentrate mixed with the regular distribution water. Traditional point-of-use systems utilize a reverse osmosis (RO) membrane configured in a spiral wound element. In the interest of space, these spiral wound elements are packed tightly with a thin feed spacer between active membrane surfaces with very little space for the feed water and concentrate to flow. The tight packing means a substantial amount of the pressure is lost moving the water longitudinally through the element. Thus the resulting pressure loss makes redistribution of the concentrate problematic. In addition, this tight packing will clog or cause fouling of the membrane if the water being fed through the system is not pretreated sufficiently. This fouling and clogging would only be increased in the event that more flow is fed through the system.

In some embodiments, the membranes include ultrafiltration (UF), nanofiltration (NF) and reverse osmosis (RO) membranes which are relatively much tighter and smoother than microfiltration (MF) membranes. With pore sizes much smaller than typical MF membranes, these membranes do not allow large contaminants to lodge in their pores. In addition, NF and RO membranes, which are often charged, can remove varying amounts of dissolved solids from the feed water stream. RO membranes are usually capable of removing more dissolved solids than nanofiltration membranes. In some embodiments, use of NF and RO membranes involves higher driving pressures than MF membranes, resulting in a much lower flux as well as lower attractive forces between the membrane surfaces, aiding in the anti-fouling nature of embodiments.

Alternatively, one or more spiral-wound membrane units can be employed in a loosely rolled configuration wherein gravity or water currents can move higher density concentrate through the configuration and away from the membrane surfaces. The membrane elements can alternatively be arrayed in various other configurations (planar, curved, corrugated, etc.) which maximize surface exposure and minimize space requirements. In a preferred configuration, these elements are arrayed vertically. The induced vessel pressure forces water through the membrane, and a gathering system collects the treated water and releases it to a location outside of the pressure vessel, such as a holding tank. The concentrate may be passed on without significant pressure loss for other uses within the building. Any suitable permeate collection configuration can be employed in the systems of preferred embodiments.

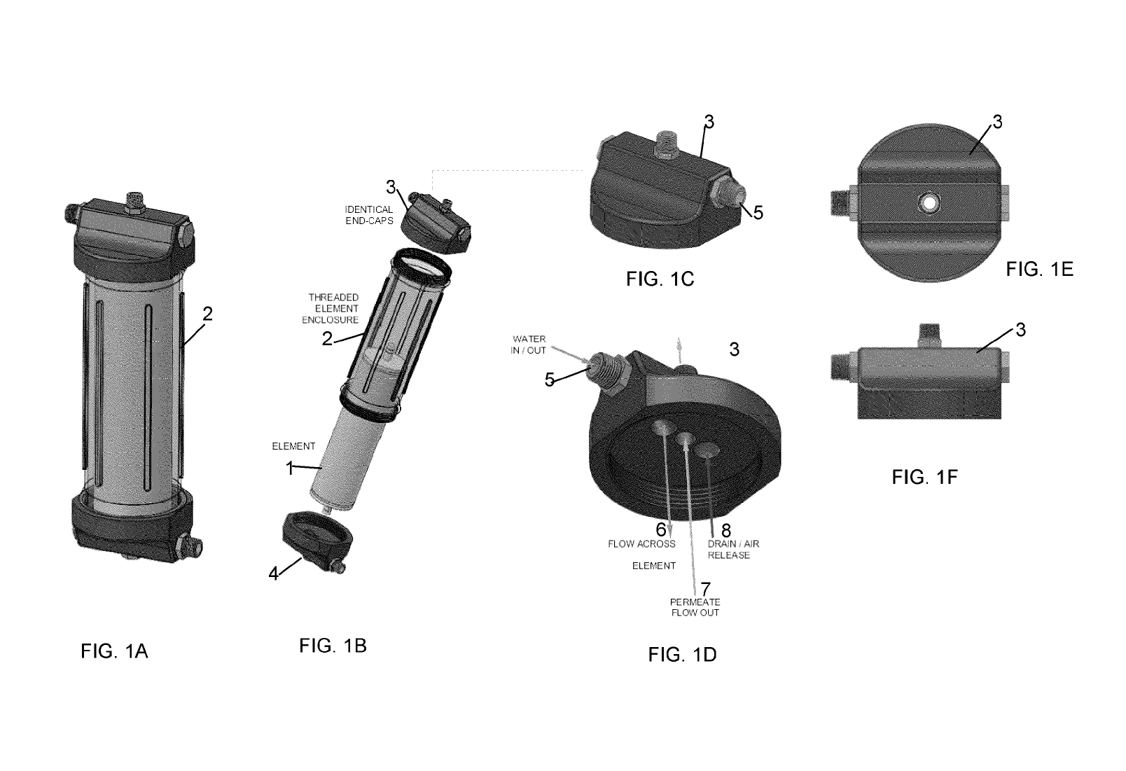

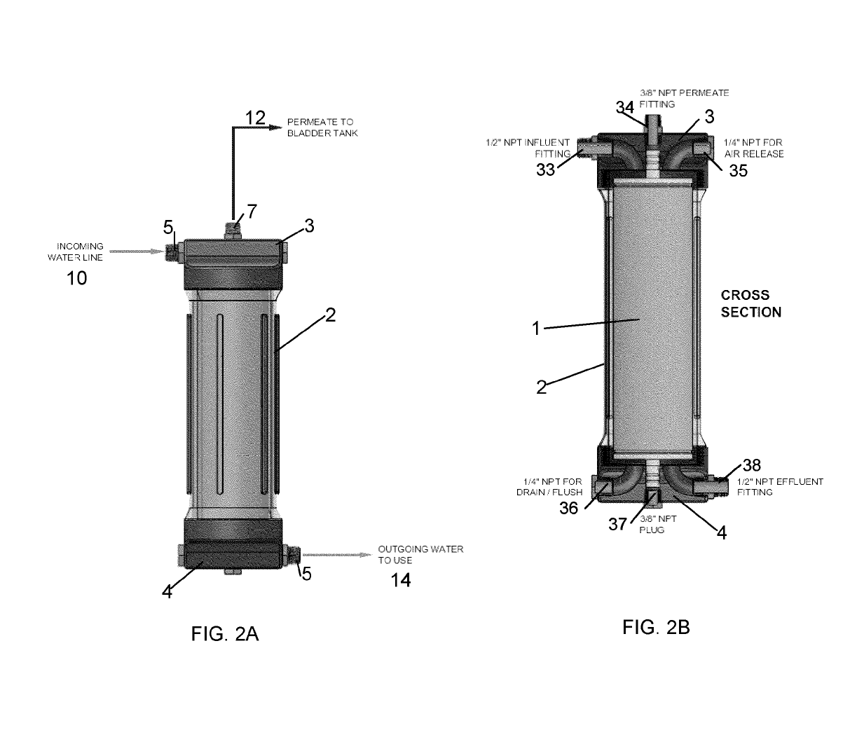

One embodiment, shown in FIGS. 1A-F and FIGS. 2A and B, includes a membrane cartridge 1 vertically disposed in a pressure vessel or element enclosure 2 having a round or circular cross-section. In some embodiments, the membrane element is a spiral-wound nanofiltration or reverse osmosis membrane element having a diameter of about 8 inches and a height of about 40 inches. In other embodiments, the membrane element in a spiral-wound configuration may have a diameter of from 1 to 50 inches, e.g., at least about 1 inch, about 2 inches, about 3 inches, about 4 inches, about 5 inches, about 6 inches, about 7 inches, about 9 inches, or about 10 inches or more. In other embodiments, the diameter of the membrane element may be between about 1 and 3 inches, between about 2 and 4 inches, between about 4 and 6 inches, between about 6 and 8 inches, between about 8 and 10 inches, and between about 10 and 12 inches. In some embodiments, the height of the membrane element may be at least about 3 inches, about 4 inches, about 5 inches, about 6 inches, about 8 inches, about 10 inches, about 12 inches, about 15 inches, about 18 inches, about 20 inches, about 25 inches, about 30 inches, about 35 inches, about 40 inches, about 45 inches, or about 50 inches. In other embodiments, the height of the membrane element may be between about 6 to 10 inches, about 10-12 inches, about 12-15 inches, about 15-20 inches, about 20-25 inches, about 25-30 inches, about 30-35 inches, about 35-40 inches, or about 40-45 inches. The pressure vessel 2 is sized to accommodate the spiral-wound membrane element 1 in a vertical configuration. In some embodiments, the pressure vessel may have a diameter that exceeds the diameter of the membrane element by about 1 inch, about 2 inches, or about 3 inches. In some embodiments, the pressure vessel may have a diameter of about 2 inches, about 3 inches, about 4 inches, about 5 inches, about 6 inches, about 10 inches, about 12 inches, or about 15 inches. In other embodiments, the height of the pressure vessel may exceed the height of the membrane element by about 1 inch, about 2 inches, about 3 inches, about 4 inches, or about 5 inches.

As further illustrated in FIGS. 1A-B and 2A-B, the pressure vessel 2 may be capped by two end pieces 3, 4. Preferably, the two end pieces 3, 4 are identical. The end pieces 3, 4 may be configured with threads to match with threads on the upper and lower openings of the cylindrical pressure vessel 2 such that the end pieces 3, 4 may be threaded or affixed to the pressure vessel 2. Each of the end pieces 3, 4 desirably has three openings to allow fluid in and out of the pressure vessel 2. As illustrated in FIG. 1D, one opening 5 in the side of the end pieces 3, 4 allows fluid into and out of the pressure vessel 2. The opening 5 may be connected to a chamber having openings 6, 7, 8. In one embodiment, opening 6 allows fluid to flow across the membrane element 1, opening 7 allows permeate to flow out of the pressure vessel 2, and opening 8 is a drain or air release opening. The configuration of the openings shown in FIG. 1D is one example and the openings may be in other configurations in other embodiments.

FIG. 2A illustrates an assembled vessel and membrane configuration, according to an embodiment. As shown in FIG. 2A, water from an incoming water line 10 may enter the vessel 2 via the opening 5 in the end piece 3. Treated water or permeate 12 can leave the vessel 2 via the opening 7. The permeate may be stored in a bladder tank for future use. Pass through or untreated or unpurified water 14 may exit the vessel 2 via the opening 5 in the end piece 4. This unpurified or untreated water 14 may return to a source water holding tank or may be routed back to the household plumbing for use. As illustrated in FIG. 2B, and discussed above, the end pieces 3, 4 may openings to allow connections to source water entering the pressure vessel 2 and permeate and concentrate exiting the pressure vessel 2. In some embodiments, the influent connection or fitting 33 is configured to attach a 0.5 inch diameter influent pipe to the pressure vessel and the effluent connection or fitting 38 is configured to attach the pressure vessel to a 0.5 inch diameter effluent pipe. In some embodiments, a small head loss of the concentrate between 0.1 psi to 0.3 psi under normal operating conditions (60 psi distribution or source water pressure) can be expected because of the wide spacing between the membrane sheets and large cross-sectional area of the pressure vessel as compared to the cross-sectional area of each of the influent and effluent connections. In some embodiments, the cross-sectional area of the pressure vessel may be about 2 times, 3 times, 4 times, 5 times, 6 times, 8 times, or about 10 times the cross-sectional area of the influent and/or the effluent pipe fittings or connections. In some embodiments, the total area of the spacing in membrane is approximately equal to the cross-sectional area of a 1.5 inch influent and/or effluent pipe.

Feed water contaminants can tend to lodge in the pores of the membranes in membrane-based treatment systems. Contaminant particles can also tend to form a coating (which may be several particles deep) on the membrane surfaces, which can block the flow of permeate through the membranes. In reverse osmosis and nanofiltration systems, contaminant particles that are relatively small (e.g., on the order of 1 micron and smaller in diameter) are especially likely to cause this type of membrane fouling.

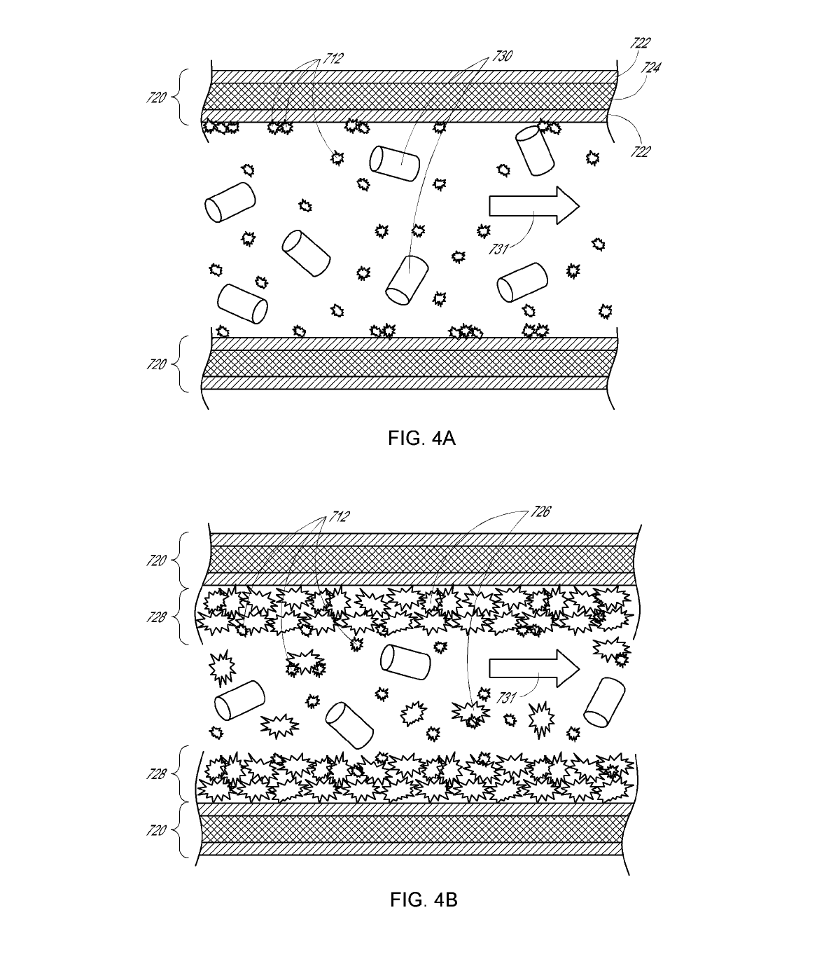

In some embodiments, antifouling particles can be added to the feed water (and/or to the membrane surfaces) to reduce or inhibit fouling of the membranes by contaminant particles. FIGS. 4A and B illustrate antifouling particles that have been added to the feed water. FIG. 4A is a schematic cross-sectional view illustrating a feed channel in one such embodiment. In the embodiment shown in FIG. 4A, pellets 730 are added to the feed water, and are suspended in the feed water along with any contaminant particles 712 that may be present. The pellets 730 can be configured to contact and loosen and/or dislodge any particles 712 that may have settled upon or near the surfaces of the membranes 722 as the pellets move with the feed water in the general direction indicated by arrow 731. The pellets can have any suitable shape, including the cylindrical shape illustrated in FIG. 4A. Other examples of suitable shapes include spherical, nonspherical, elongated, oblong, cubic, cuboid, prismatic, pyramid, conical, or irregular shapes. The pellets can have any suitable size. In some embodiments, the pellets can have major dimensions of or an overall average major dimension of from about 0.1 mm to about 2.0 mm, e.g., about 0.1 mm, about 0.2 mm, about 0.3 mm, about 0.4 mm, about 0.5 mm, about 1.0 mm, about 1.5 mm, about 2.0 mm, or a major dimension greater than any of these numbers, less than any of these numbers, or within a range defined by any of these numbers. In some embodiments, the pellets can have a major dimension less than or equal to about half the distance between the membranes 722. For example, in an embodiment employing a membrane spacing of about 2.5 mm, the pellets can have a major dimension of, for example, less than or equal to about 1.25 mm. In an embodiment employing a membrane spacing of about 3.2 mm, the pellets can have a major dimension of, for example, less than or equal to about 1.6 mm. The pellets can comprise any material suitable for their intended purpose, such as, for example, plastic, ceramic, or other materials. The pellets can be nonporous or slightly porous, and they can be solid or hollow. The pellets can have any suitable density, including, for example, a density of about 0.9 g/mL, about 1.0 g/mL, about 1.1 g/mL, about 1.2 g/mL, about 1.5 g/mL, or a density greater than any of these numbers, less than any of these numbers, or within a range defined by any two of these numbers.

FIG. 4B is a schematic cross-sectional view of a feed channel in yet another embodiment. FIG. 4B shows antifouling particles 726 and pellets 730 added to the feed water and suspended with the contaminant particles 712 that are already present. FIG. 4B also shows a layer 728 of antifouling particles 726 coating the membranes 722. In an embodiment employing both antifouling particles and pellets to inhibit membrane fouling, the pellets can function to dislodge contaminant particles as well as any antifouling particles residing on the membrane surfaces. In this way, the addition of the pellets can encourage movement of the antifouling particles through the feed channels. The addition of the pellets can also encourage a constant exchange of antifouling particles coating the membrane surfaces.

In some embodiments, an antifouling layer may be formed on the surface of one or more membranes to inhibit or prevent contaminant particles from forming a water-impermeable coating on the membrane surfaces and thus fouling the membranes. In some embodiments, the antifouling layer can comprise a plurality of antifouling particles. In other embodiments, the antifouling layer can comprise a continuous layer of an adsorbent material. In some embodiments, the antifouling layer can be formed on the membrane surfaces before the membrane elements are installed in the pressure vessel. In other embodiments, the antifouling layer can be built up naturally during the treatment process, by supplying antifouling particles to the feed water in suspension and allowing them to adhere to and coat the membrane surfaces. The addition of an antifouling layer to the membrane surfaces can serve to inhibit or prevent contaminant particles from forming a nonporous or water-impermeable coating on the membrane surfaces and thus fouling the membranes.

The membranes 722 shown in FIGS. 4A and B can be, for example, osmotic membranes (that is, NF or RO) membranes. The antifouling particles 726 that are added to the feed water can be, for example, diatomaceous earth particles, activated carbon particles, or particles of any other material with suitable porosity and/or specific surface area for their intended purpose. The material can be relatively inert, or can be selected to react with particular contaminants, such as industrial contaminants. Additional examples of materials that can be used for antifouling particles in embodiments include clay, bentonite, zeolite, and pearlite. In some embodiments, the antifouling particles can be selected to have a suitable porosity and/or specific surface area and size to attract and adsorb particular contaminant particles, such as, for example, contaminant particles approximately 1 micron in diameter and smaller. For example, in some embodiments, the antifouling particles can have a diameter (or a major dimension) of 0.5 microns or more, 1.0 microns or more, 1.5 microns or more, 2.0 microns or more, or a diameter (or a major dimension) greater than any of these numbers, less than any of these numbers, or within a range defined by any two of these numbers. Also in some embodiments, the antifouling particles can have a specific surface area of 10 m²/g or more, 20 m²/g or more, 30 m²/g or more, 40 m²/g or more, 50 m²/g or more, 60 m²/g or more, 70 m²/g or more, 80 m²/g or more, 90 m²/g or more, 100 m²/g or more, 200 m²/g or more, 300 m²/g or more, 400 m²/g or more, 500 m²/g or more, 1000 m²/g or more, 1500 m²/g or more, or a specific surface area greater than any of these numbers, less than any of these numbers, or within a range defined by any two of these numbers. Alternatively or in addition to antifouling particles having a high porosity and/or surface area, absorbent particles, highly charged particles, magnetic particles, or other particles can be added to feed water as antifouling particles in various embodiments, for example to remove specific contaminants. Additional details regarding adding antifouling particles to the feedwater and/or membrane surfaces may be found in U.S. Pat. No. 8,685,252, entitled “WATER TREATMENT SYSTEMS AND METHODS,” which is hereby incorporated by reference in its entirety.

In some embodiments, the concentrate is also flushed through with each use of non-potable water throughout the building. In this way nearly 100% of the water is beneficially used. There is little or no waste, though the water for other, non-potable or non-purified, uses in the building will have a slightly elevated concentration of constituents removed by the membrane. However this elevated concentration is desirably insignificant as traditionally potable uses are far smaller than non-potable uses.

For example, if a household uses one cubic meter a day for non-potable loads and 0.1 cubic meters for potable uses and the membrane cuts total dissolved solids from 600 mg/liter to 200 mg/liter then the resulting non-potable loads would receive 644 mg/liter of total dissolved solids (TDS) concentration. This concentration is just 44 mg/liter above (just 7.4% higher) what it otherwise would be. For non-potable uses this is not of concern. This example assumes a 10 to 1 ratio of non-potable to potable load. In many parts of the world the ratio can be much higher making the corresponding concentrate that much more dilute.

In some embodiments, a configuration of the system can also be applied in commercial and industrial settings that require purified water and have a larger less-purified water load. This less-purified load preferably should be in the order of 2 to 10 times the load of the higher purified load to minimize the effects of concentration. An example could be in a restaurant that uses non-purified water for dishwashing, but needs purified water for cooking and drinking. Another example in which embodiments of the system could be used is an industrial facility that has a large cooling water feed and waste stream. This type of facility typically also requires much smaller amount of purified water for their boilers. In some embodiments, various embodiments of the system can process 5 gallons to 100 gallons of water per day. In other embodiments, the system can process at least 5 gallons, at least 15 gallons, at least 25 gallons, at least 30 gallons, at least 40 gallons, at least 50 gallons, at least 60 gallons, at least 75 gallons, at least 85 gallons, at least 100 gallons, at least 115 gallons or at least 125 gallons of water per day. In other embodiments for commercial uses, such as an apartment or office building, the system can process at least 150 gallons, at least 200 gallons, at least 300 gallons, or at least 500 gallons per day.

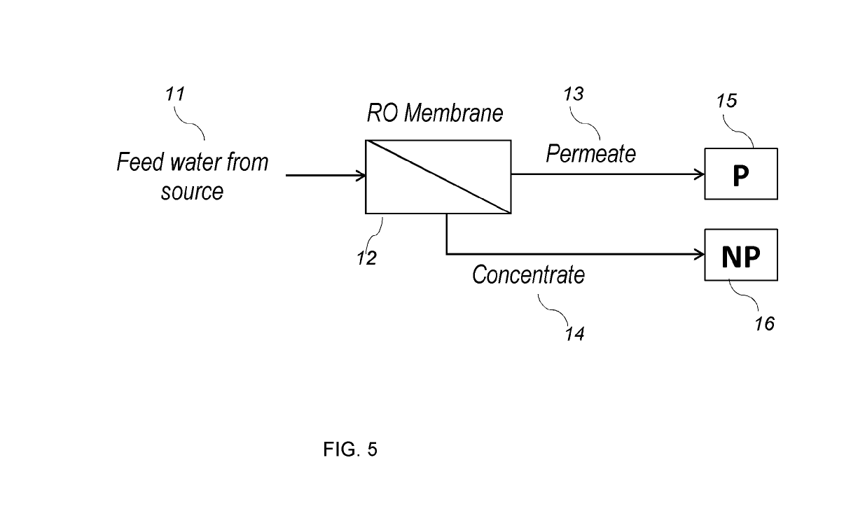

FIG. 5 is a process flow diagram illustrating a method of treating water and collecting the concentrate for non-potable uses, according to an embodiment. Pressurized source water from a feed water source flows substantially freely through the membrane element contained within a pressure vessel. The pressure differential between the source water side of the membranes and the permeate side of the membranes causes permeate to flow to the low pressure (permeate) side of the membranes. The source water 11 enters the system from a distribution system, local well, or source water tank. The source water 11 is fed into an in-line membrane vessel 12 containing a spiral-wound reverse osmosis membrane element, or a nanofiltration spiral-wound element. The permeate 13 water is fed to a potable water use 15. The concentrate 14, which is normally disposed of, is fed to non-potable loads 16 in the building (i.e. cleaning, laundry, toilets, showers, etc.). While existing technologies can collect the concentrate 14 for use on non-potable loads 16, these existing technologies do so at little to no pressure, that is, the water is stored in a vessel and moved to its non-potable use by other means. The system preferably retains the pressure of the concentrate and mixes the concentrate with additional feed water coming into the building and through the membrane element. In some embodiments, the pressure of the water entering the system from a distribution system may be about 60 psi with the concentrate exiting the system at a pressure of about 59 psi. In other embodiments, the pressure of the source water that may be treated by the system may be between 15 psi and 100 psi, between 25 psi and 85 psi, or between 50 psi and 70 psi. In other embodiments, the pressure of the source water that may be treated by a system designed for commercial applications may be between 300 psi and 500 psi. In some embodiments, the head loss is between 0.1 psi and 0.3 psi. In other embodiments, the head loss is between 0.1 psi and 0.5 psi, between 0.5 psi and 1 psi, between 1 psi and 2 psi, or between 2 psi and 4 psi. The term “non-potable” use may refer to any use not requiring purified water.

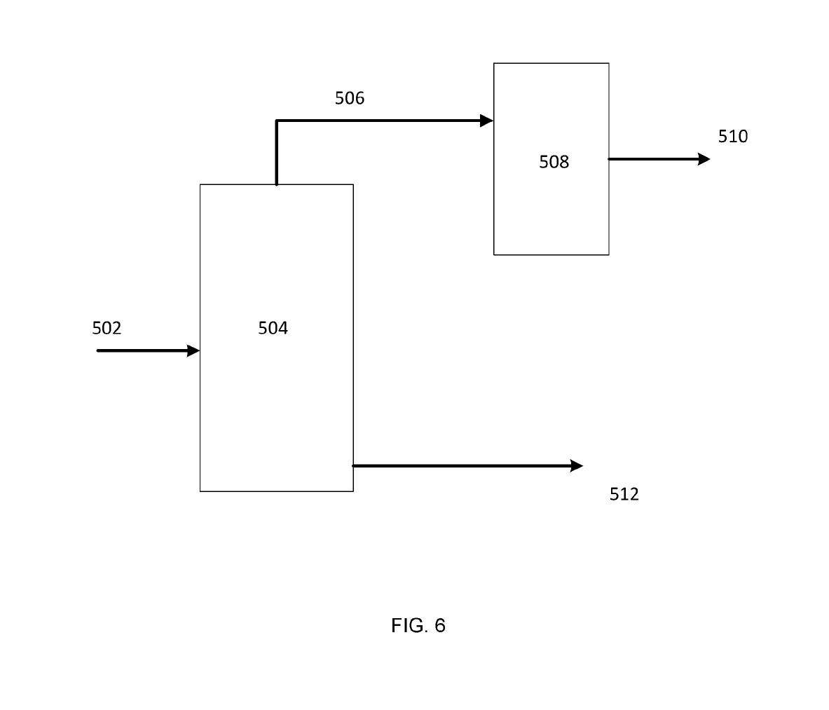

FIG. 6 is a process flow diagram illustrating a method of treating water and collecting the concentrate for non-potable uses, according to another embodiment. Pressurized source water 502 from a feed water source flows into the pressure vessel 504 containing the membrane element. A pressure differential between the feed water source and the permeate side of the membrane drives permeate to flow to the low side (permeate side) of the membrane. The permeate flow 506 is contained within a tank or other storage device 508 for use. This water stored in the tank 508 may be fed as needed to loads requiring or desiring treated or processed water. The concentrate 512, desirably at the same pressure as the source water 502, is fed to non-potable loads.

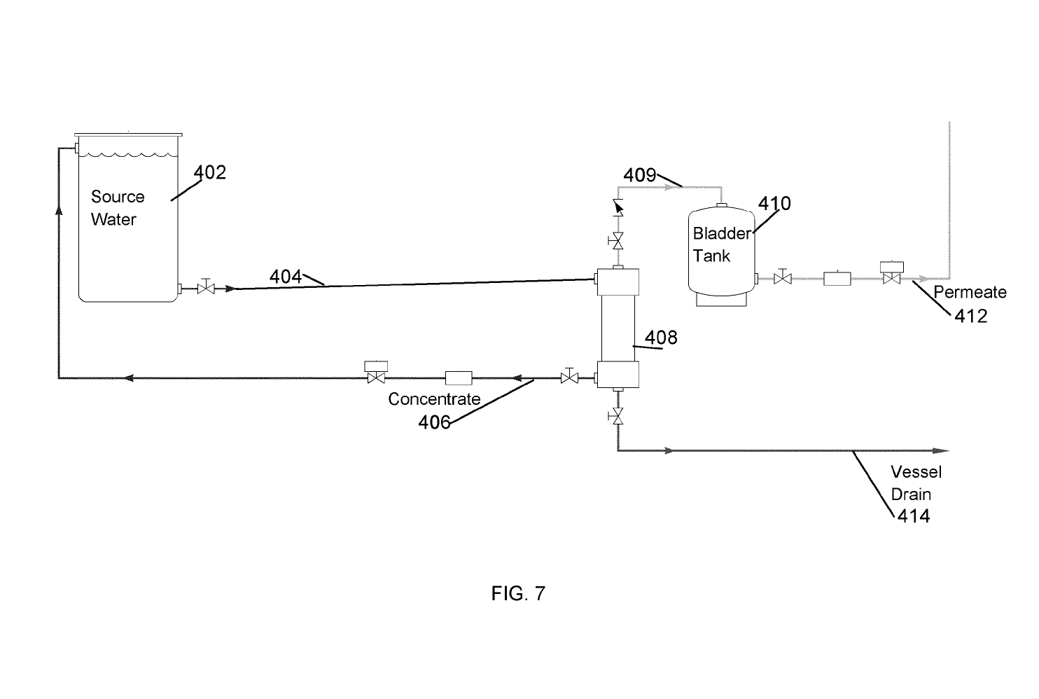

Another embodiment of a process flow diagram illustrating a method of treating water and collecting the concentrate for other, non-purified water uses, is shown in FIG. 7. Water from a source water containment unit, such as a tank or distribution system 402 passes from the source water tank to the pressure vessel 408. Treated water or permeate 409 exits the pressure vessel 408 and passes to a bladder tank 410. This treated water or permeate may then be directed 412 to any use requiring purified or treated water. The concentrate or pass through fluid 406 exits the pressure vessel 408, desirably at the same or substantially the same pressure as the source water 404. Unlike traditional water treatment systems, the concentrate is waste but may be routed to other uses not requiring treated or purified water. In some embodiments, such as the embodiment shown in FIG. 6, the concentrate may be transferred back to the source water containment unit or tank 402 to be mixed with the source water and used for other, non-potable uses. The pressure vessel 408 is also configured with a drain 414 that may be used to clean or empty the pressure vessel 408 if the membrane becomes clogged. The lines 404, 406, 409, 412, and 414 may include valves or other flow and/or pressure regulation devices depending on the application.

As discussed above, the membranes used in the system may be pre-treated or coated with antifouling particles to inhibit or prevent the adhesion of contaminants to the membrane surface and cause membrane fouling or clogging. Desirably, the membrane used in the system will require less maintenance and cleaning than membranes used with traditional point of use or point of entry systems. The antifouling coating on the membranes may act similar to a sponge. Initially, the membrane coating is porous and water may easily pass through the membrane. As the membrane fouls, additional pressure may be required to pass water through the membrane. The membrane typically requires a “rest cycle” or other period of time to unclog. Storing permeate or treated water in a bladder tank provides an automatic rest cycle for the system to allow the membrane to unclog. As the bladder tank fills, the pressure on the permeate side of the membrane element increases. As the system relies on the pressure differential between the source or feed water and the permeate to drive water across the membrane, as the permeate pressure increases, the pressure differential decreases. As a result, the flow of water past the surface of the membrane in the pressure vessel slows or stops. This slowing allows the membrane to declog while minimizing required maintenance.

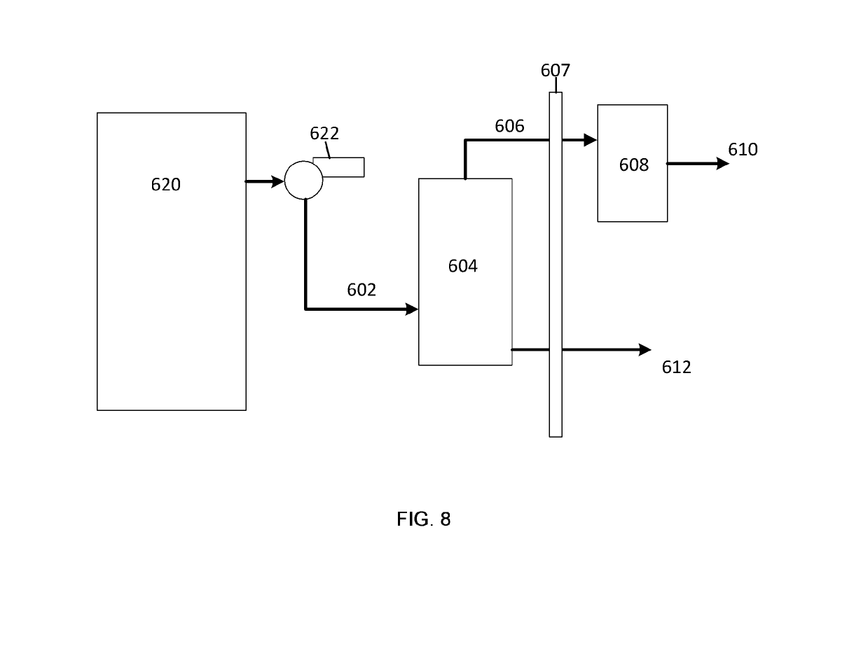

An additional embodiment of a process flow diagram illustrating a method of treating water and collecting the concentrate for other, non-purified water uses, is shown in FIG. 8. As illustrated, water from a feed water source tank or other source 620 is directed through a tank booster or pump 622. The booster 622 can increase the pressure of the feed water and deliver this feed water 602 to the pressure vessel 604 at an elevated pressure. The permeate 606 may be stored in a tank 608 as discussed above. Permeate 610 may be drawn from the bladder 608 for potable uses. The concentrate 612 may be used for other, non-potable uses, as previously discussed. The feed water source, such as a tank 620, the pump or booster 622, and the pressure vessel 604 containing the membrane element may be located on an exterior surface of a building, as indicated by the wall 607. In some embodiments, the tank 620, the pump or booster 622, and/or the pressure vessel 604 may be stored on the roof of a building and gravitational forces may be used to assist with the flow of permeate and concentrate from the pressure vessel 604. Desirably, the tank 608 is located close to the point of use for the permeate.

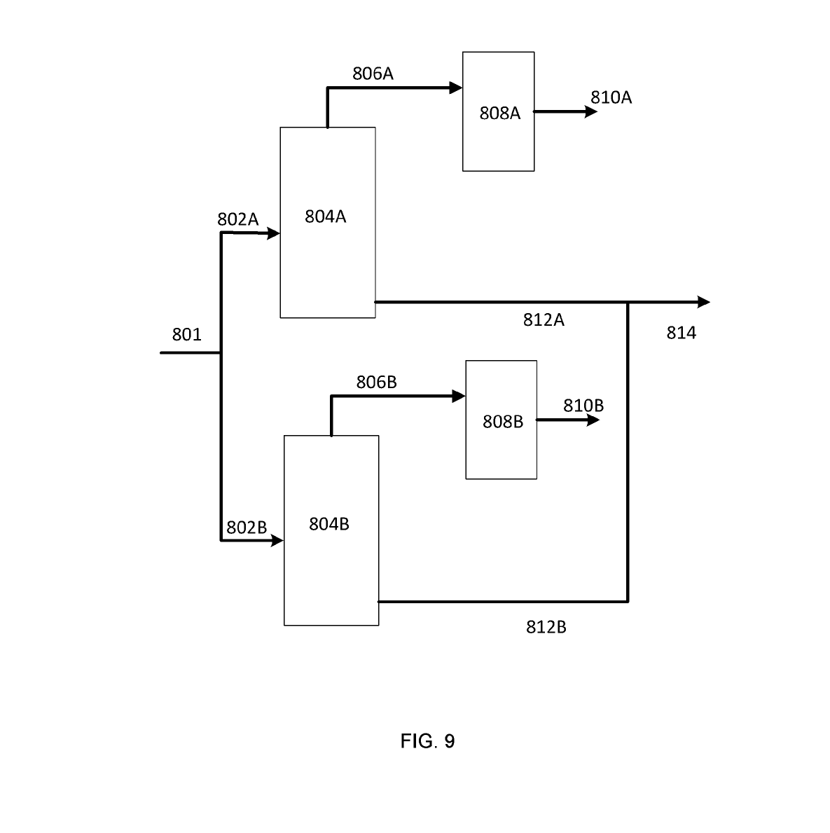

An additional embodiment of a process flow diagram illustrating a method of treating water and collecting the concentrate for other, non-purified water use, is shown in FIG. 9. In this embodiment, two pressure vessels 804A, 804B are arranged in parallel to treat a larger volume of source feed water 801 than may be possible with a single pressure vessel and membrane element. The source feed water 801 may be delivered via routings 802A, 902B to the pressure vessels 804A, 804B. The treated water or permeate 806A, 806B may be sent to two separate tanks 808A, 808B, or may be sent to a single tank. The concentrate flows 812A, 812B from the pressure vessels 804A, 804B may be routed together to be delivered for non-potable uses 814. In other embodiments, the concentrate stream from each pressure vessel may be kept separate.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations.” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together. B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1. A water treatment system, comprising:
a vessel configured to hold a volume of a liquid containing membrane foulants, the vessel having an inlet and a permeate outlet, the vessel installed in line with a water feed line; and
a membrane element disposed within the pressure vessel, the membrane element having one or more membrane sheets spaced apart at a spacing from about 1 mm to about 8 mm; and
an antifouling apparatus configured to deliver a supply of antifouling particles to the liquid, wherein the antifouling particles are configured to coat membrane surfaces of the membrane element to form a protective layer that attracts and holds membrane foulants while allowing passage of permeate through the membrane element;
wherein the spacing of the membrane sheets of the membrane element is configured to reduce a longitudinal head loss of the water feed such that a concentrate stream maintains a preselected distribution pressure.

2. The system of claim 1, wherein the membrane element is a spiral-wound membrane element.

3. The system of claim 1, wherein the membrane element is a reverse-osmosis or nanofiltration membrane element.

4. The system of claim 1, wherein the antifouling particles have a specific surface area of 10 m²/g or more.

5. The system of claim 1, wherein the antifouling particles have a specific surface area of 30 m²/g or more.

6. The system of claim 1, wherein the antifouling particles have a specific surface area of 500 m²/g or more.

7. The system of claim 1, wherein the antifouling particles have a major dimension of 0.5 microns or more.

8. The system of claim 1, wherein the antifouling particles have a major dimension of 1.0 micron or more.

9. The system of claim 1, wherein the antifouling particles are configured to adsorb membrane foulants having a diameter of 1 micron or less.

10. The system of claim 1, wherein the antifouling particles comprise diatomaceous earth.

11. The system of claim 1, wherein the antifouling particles comprise activated carbon.

12. The system of claim 1, wherein the one or more membrane sheets of the membrane element are spaced apart at a spacing of at least 3 mm.

13. The system of claim 1, further comprising a supply of pellets configured to inhibit the buildup of membrane foulants on the membrane element.

14. The system of claim 13, wherein a volume of the pellets is between about 0.5% and about 10% of the volume of the liquid.

15. The system of claim 13, wherein the pellets have a density greater than about 1.0 g/mL.

16. The system of claim 13, wherein the pellets have nonspherical shape.

17. The system of claim 13, wherein the pellets have a major dimension which is less than or equal to about half the spacing between the one or more membrane sheets of the spiral-wound reverse osmosis or nanofiltration membrane element.

18. A method of treating a liquid containing membrane foulants, the method comprising:
supplying a liquid containing membrane foulants to a vessel, the vessel having an inlet, a permeate outlet, and a membrane element disposed within the vessel, the vessel installed in line with a water feed line, the membrane element having one or more membrane sheets spaced apart at a spacing of from about 1 mm to about 8 mm;
coating membrane surfaces of the membrane element to form a protective layer that attracts and holds membrane foulants while allowing passage of permeate through the membrane element;
applying a pressure differential across the membrane element so as to drive a filtration process across the membrane element, wherein the spacing of the membrane sheets reduces a longitudinal head loss of the water feed line such that the feed line or a concentrate stream maintains a distribution pressure; and
collecting the permeate from the permeate outlet in a collection vessel such that as the volume of permeate in the collection vessel increases the pressure differential across the membrane element decreases to slow the filtration process across the membrane element.

19. The method of claim 18, wherein the membrane element is a spiral-wound membrane element.

20. The method of claim 18, wherein the membrane element is a reverse-osmosis or nanofiltration membrane element.

21. (canceled)

22. (canceled)
